(19) United States
(12) Patent Application Publication
(10) Pub. No.: US 2009/0324812 A1
(43) Pub. Date: Dec. 31, 2009

(54) FUEL CELL SEPARATOR AND METHOD FOR MANUFACTURING SAME

(76) Inventors: Kazutaka Iizuka, Aichi-ken (JP); Masakazu Suzuki, Aichi-ken (JP); Masanori MAtsukawa, Aichi-ken (JP); Kenji Dewaki, Aichi-ken (JP); Shinji Dewaki, Gifu-ken (JP)

Correspondence Address: KENYON & KENYON LLP, 1500 K STREET N.W., SUITE 700, WASHINGTON, DC, 20005, US

(21) Appl. No.: 12/377,941

(22) PCT Filed: Aug. 10, 2007
(86) PCT No.: PCT/JP2007/065993

§ 371 Date: Feb. 18, 2009

(30) Foreign Application Priority Data
Sep. 4, 2006 (JP) 2006-239442

(51) Int. Cl. B05D 5/12; B32B 37/02

(52) U.S. Cl. 427/115; 156/60

(57) ABSTRACT

A fuel cell separator is provided with an opening that functions as a manifold. A resin coating is formed within the peripheral area of the fuel cell separator, in a state where the power generation area is masked with a masking jig. The resin coating is formed so that the separator substrate is exposed within at least a portion of the peripheral area. Subsequently, the masking jig is removed, and a conductive coating is formed within the power generation area of the fuel cell separator, the peripheral area of which has been masked by the resin coating. The conductive coating is formed by causing electricity to flow through the portion of the peripheral area where the separator substrate is exposed.

### TECHNICAL FIELD

The present invention relates to a fuel cell separator, and relates particularly to a coating technology for a fuel cell separator.

### BACKGROUND ART

Fuel cells, which convert the chemical energy obtained by reacting a fuel gas comprising hydrogen with an oxidizing gas comprising oxygen to electrical energy are already known. Fuel cells are used, for example, by mounting in vehicles or the like, and can be used as the power source or the like for a motor used for driving the vehicle.

In order to prevent corrosion caused by the water generated as a result of the chemical reaction, the components used in fuel cells must exhibit corrosion resistance. For example, the separator used in a fuel cell (namely, the fuel cell separator) is typically covered with a resin coating in order to enhance the corrosion resistance.

Accordingly, a variety of conventional techniques have been proposed for coating fuel cell separators. For example, Patent Document 1 (JP2006-80026A) discloses a technique in which a primer that binds a sealing material such as a resin is formed by electrodeposition coating within an outer peripheral portion of a fuel cell separator.

### DISCLOSURE OF INVENTION

The inventors of the present invention continued research and development of new coating techniques based on the innovative technology disclosed in Patent Document 1. In particular, they continued research and development of surface treatments of the fuel cell separator conducted following formation of the resin coating.

The present invention has been developed in light of this type of background, and has an advantage of providing a novel coating technique for a fuel cell separator.

In order to realize the above advantage, a fuel cell separator of a preferred aspect of the present invention is a fuel cell separator comprising a conductive coating and a resin coating formed on a plate-like separator substrate, wherein the separator substrate has a power generation area that faces a power generating layer and a peripheral area that comprises an opening that functions as a manifold, the peripheral area is coated with a resin coating so that the separator substrate is exposed within at least a portion of the peripheral area whereas the opening that functions as a manifold is coated with the resin coating, and the power generation area is coated with a conductive coating by causing electricity to flow through the portion of the peripheral area where the separator substrate is exposed.

In the above aspect, the conductive coating is formed using a material for which at least one of the conductivity and the corrosion resistance is superior to that of the surface of the separator substrate. Specific examples of the conductive coating include metal plating and the like. Furthermore, the conductive coating and the resin coating may be formed, for example, using electrodeposition treatments.

According to the above aspect, a fuel cell separator can be provided in which the opening that functions as a manifold is coated with a resin coating and the power generation area is coated with a conductive coating. Furthermore, because formation of the conductive coating is performed by causing electricity to flow through the portion of the peripheral area where the separator substrate is exposed, the current flow for the conductive coating can be generated comparatively easily. Moreover, current concentration or the like is unlikely to occur within the power generation area, enabling the formation of a more uniform and dense conductive coating.

In a preferred aspect of the fuel cell separator, the portion of the peripheral area where the separator substrate is exposed is a positioning portion which, when a plurality of unit cells are laminated together to assemble a fuel cell, is used for positioning the plurality of unit cells relative to each other.

Furthermore, in order to realize the advantage described above, a manufacturing method according to a preferred aspect of the present invention is a method for manufacturing a fuel cell separator comprising a conductive coating and a resin coating formed on a plate-like separator substrate, the method comprising: a first coating step of forming a resin coating within a peripheral area of the separator substrate that comprises an opening that functions as a manifold, so that the separator substrate is exposed within at least a portion of the peripheral area, and a second coating step of forming a conductive coating within a power generation area of the separator substrate that faces a power generating layer, by causing electricity to flow through the separator substrate from the portion of the peripheral area where the separator substrate is exposed.

In a preferred aspect, the second coating step comprises coating the separator substrate, using a metal plating as the conductive coating, with the peripheral area comprising the opening masked with the resin coating of the first coating step.

In another preferred aspect, when a plurality of unit cells are laminated together to assemble a fuel cell, the portion of the peripheral area where the separator substrate is exposed is used for positioning the plurality of unit cells relative to each other.

The present invention provides a novel coating technique for a fuel cell separator. Accordingly, a fuel cell separator can be provided in which, for example, an opening that functions as a manifold is coated with a resin coating, and a conductive coating is formed within the power generation area.

Furthermore, by forming the conductive coating within the power generation area following formation of the resin coating within the peripheral area of the separator substrate, the resin coating functions as a mask during formation of the conductive coating, meaning a separate masking operation is not required for the conductive coating.

Furthermore, by forming the conductive coating by causing electricity to flow through the portion of the peripheral area where the separator substrate is exposed, the current flow for the conductive coating can be generated comparatively easily. Moreover, current concentration or the like is unlikely to occur within the power generation area, enabling the formation of a more uniform and dense conductive coating.

### BRIEF DESCRIPTION OF THE DRAWINGS

FIG. 1 is a schematic illustration of a fuel cell separator 10 according to the present invention.

FIG. 2 is a diagram describing a state in which a fuel cell separator is masked with a masking jig.

FIG. 3 is a diagram describing the construction of a masking jig.

FIG. 4 is a diagram describing a coating treatment for a fuel cell separator.

### BEST MODE FOR CARRYING OUT THE INVENTION

A preferred embodiment of the present invention is described below.

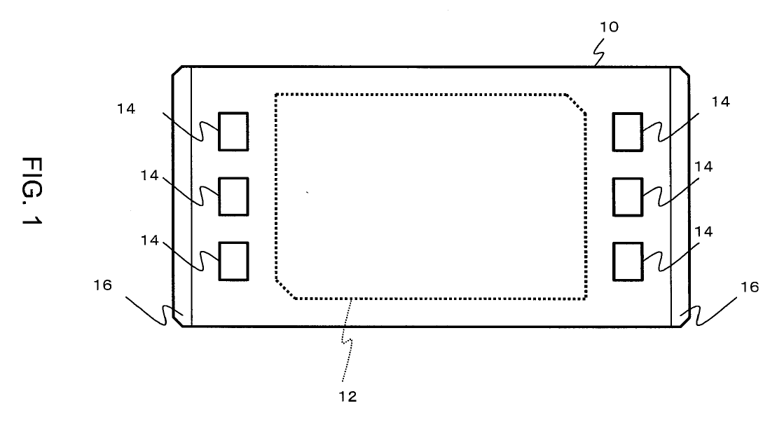

FIG. 1 describes a preferred embodiment of the present invention, and represents a schematic illustration of a fuel cell separator 10 according to the present invention.

In the fuel cell separator 10, the upper and lower surfaces are formed of a substantially rectangular plate-like member. The fuel cell separator 10 is formed from a material that exhibits conductivity such as a SUS material or carbon.

A power generation area 12 that faces a power generating layer is provided in the center of the substantially rectangular surface of the fuel cell separator 10. For example, in a case where a unit cell is formed be sandwiching a MEA (membrane electrode assembly) that functions as a power generating layer between two fuel cell separators 10, the MEA is laminated so as to face the power generation area 12 of the fuel cell separators 10.

A fuel cell is then formed by laminating a plurality of these unit cells each comprising a MEA sandwiched between two fuel cell separators 10.

Furthermore, a plurality of openings 14 and short side portions 16 are provided in the peripheral portion around the substantially rectangular surface of the fuel cell separator 10, namely, in the peripheral area that surrounds the power generation area 12 but excludes the power generation area 12. In FIG. 1, three openings 14 are provided at each end in the lengthwise direction of the fuel cell separator 10, and a short side portion 16 is provided at each end in the lengthwise direction (the left and right ends). The positioning and shape of the openings 14 and/or the short side portions 16 illustrated in FIG. 1 merely represent one possible example.

When a fuel cell is formed using this fuel cell separator 10, the openings 14 provided in the fuel cell separator 10 function as a manifold. The water and the like generated following the chemical reaction between the fuel gas and the oxidizing gas flows through the manifold. Accordingly, in order to prevent corrosion caused by the generated water, the openings 14 that form the manifold are coated with a resin coating.

The resin coating is formed across substantially all of the peripheral area of the fuel cell separator 10. In FIG. 1, the resin coating is formed across the entire area (excluding the short side portions 16) outside of the power generation area 12 of the fuel cell separator 10. On the other hand, a conductive coating is formed across substantially all of the power generation area 12. In the present embodiment, during formation of the resin coating within the peripheral area of the fuel cell separator 10, a masking jig is used to mask those areas that do not require a resin coating.

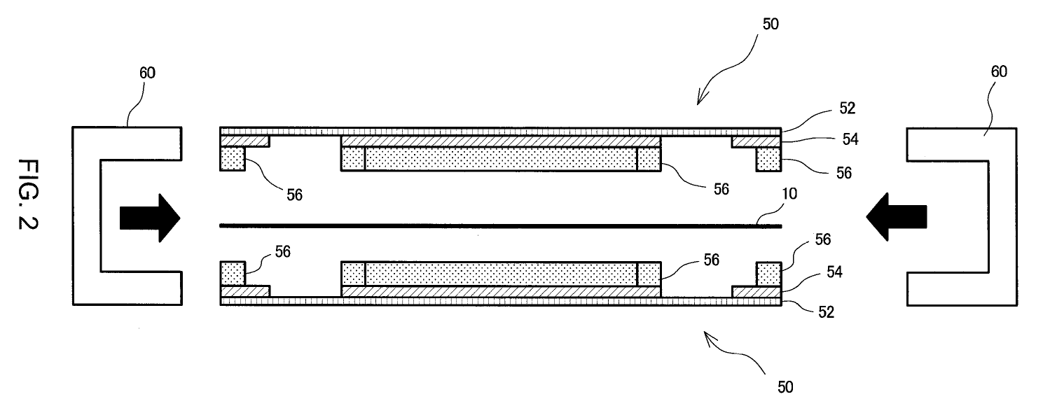

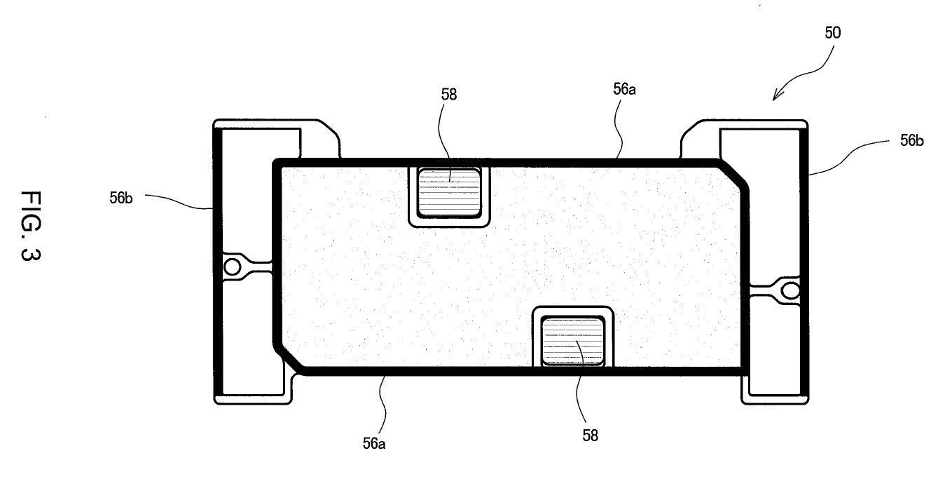

FIG. 2 and FIG. 3 are diagrams that describe a masking jig 50 used in the present embodiment. The masking jig 50 sandwiches the plate-like fuel cell separator 10 from both the upper and lower surfaces, and masks those areas on the upper and lower surfaces of the fuel cell separator 10 that do not require a resin coating.

FIG. 2 is a diagram describing a state in which the fuel cell separator 10 is masked with the masking jig 50. FIG. 2 illustrates a state in which the fuel cell separator 10 is sandwiched between two masking jigs 50, viewed from the side surface (the long side) of the fuel cell separator 10.

As illustrated in FIG. 2, during the masking process, two masking jigs 50 corresponding with the upper and lower (top and bottom) surfaces of the fuel cell separator 10 are used. Each masking jig 50 has a structure in which a cage-like frame 54 is laminated to a sheet-like resin protective material 52, and a masking material 56 is laminated to the frame 54.

Once the two masking jigs 50 are used to sandwich the fuel cell separator 10 and are positioned in close contact with the fuel cell separator 10, two clamping jigs 60 are fitted from the two ends in the lengthwise direction (the left and right ends), namely from the short sides, of the fuel cell separator 10. As a result, the two masking jigs 50 are secured by the two clamping jigs 60 in an arrangement where the masking jigs 50 sandwich the fuel cell separator 10.

FIG. 3 is a diagram describing the construction of the masking jig 50, and illustrates the masking jig 50 viewed from the side of the surface that contacts the fuel cell separator 10.

A cage-like masking material 56a is provided in the center of the masking jig 50. The masking material 56a is provided so as to surround the area in the center of the masking jig 50. The area surrounded by the masking material 56a corresponds with the power generation area (symbol 12 in FIG. 1) of the fuel cell separator.

When the masking jigs 50 are sandwiched on both sides of the fuel cell separator, the masking material 56a makes close contact around the outer periphery of the power generation area of the fuel cell separator. The masking material 56a is provided with no gaps around the entire periphery, and by bringing the masking material 56a into close contact around the outer periphery of the power generation area, the entire power generation area is masked.

The masking jig 50 is provided with conductive portions 58 inside the area surrounded by the masking material 56a. When the masking material 56a is brought into close contact around the outer periphery of the power generation area, these conductive portions 58 contact the fuel cell separator. Then, during masking with the masking material 56a, a voltage is applied from the conductive portions 58 to the fuel cell separator. As described below, as a result of the voltage applied via the conductive portions 58, a resin is electrodeposited onto the surface of the fuel cell separator.

Furthermore, a rod-like masking material 56b is provided across the short side of the masking jig 50 at each end of the masking jig 50 in the lengthwise direction (namely, the left and right ends). When the masking jigs 50 are sandwiched on both sides of the fuel cell separator, the rod-like masking materials 56b come into close contact across the short side of the fuel cell separator at both ends of the fuel cell separator in the lengthwise direction.

In the present embodiment, a resin coating is formed on the fuel cell separator using the masking jigs 50. Moreover, following formation of the resin coating, a conductive coating is formed on the fuel cell separator. Accordingly, next is a description of a coating treatment of the present embodiment.

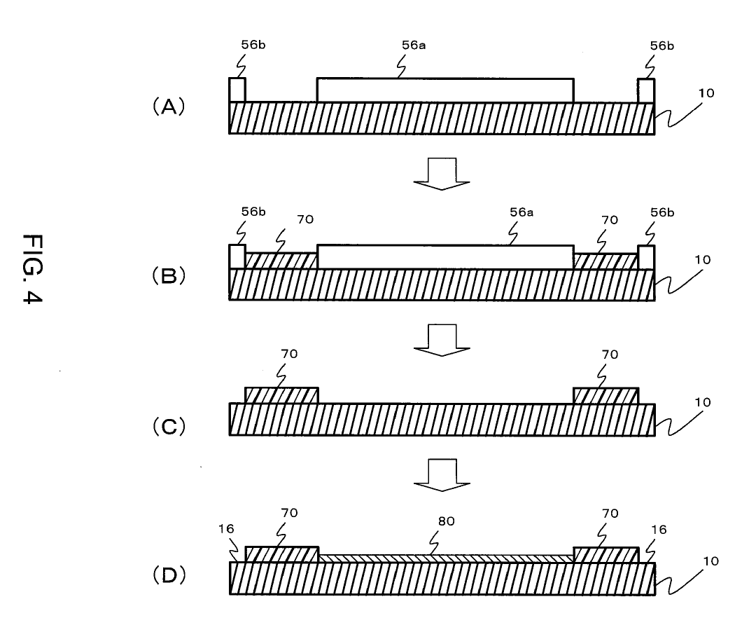

FIG. 4 is a diagram describing the coating treatment according to the present embodiment. FIGS. 4(A) to 4(D) illustrate the surface portion of the fuel cell separator 10 in each of the steps of the coating treatment. FIGS. 4(A) to 4(D) are each illustrated from the side surface (the long side) of the fuel cell separator 10. Moreover, although FIG. 4 only illustrates the coating treatment for one surface (the upper surface) of the fuel cell separator 10, the same coating treatment is also performed on the other surface (the lower surface) of the fuel cell separator 10.

FIG. 4(A) illustrates a state in which the surface of the fuel cell separator 10 has been masked. In other words, FIG. 4(A) illustrates a state in which a masking jig (symbol 50 in FIG. 3) has been laminated to the surface of the fuel cell separator 10, with the masking materials 56a and 56b of the masking jig in close contact with the surface of the fuel cell separator 10.

As described above (see FIG. 2 and FIG. 3), the masking material 56a is brought into close contact around the outer periphery of the power generation area of the fuel cell separator 10, thereby masking the entire power generation area. In other words, in FIG. 4(A), the surface of the fuel cell separator 10 that contacts the masking material 56a is masked. Furthermore, the rod-like masking materials 56b are provided across the short sides of the fuel cell separator 10 at both ends of the fuel cell separator 10 in the lengthwise direction (namely, the left and right ends). In other words, in FIG. 4(A), those portions of the fuel cell separator 10 that contact the masking materials 56b (namely, the short side portions 16 in FIG. 4(D)) are also masked.

Subsequently, as illustrated in FIG. 4(B), the surface of the fuel cell separator 10 is coated with a resin film 70 while masked with the masking materials 56a and 56b.

The coating of the resin film 70 is performed using an electrodeposition treatment (for example, a polyimide or polyamideimide electrodeposition), wherein a cationic resin obtained by ionizing a portion of a resin powder is electrodeposited on the surface of the fuel cell separator 10. During the electrodeposition treatment, by immersing the fuel cell separator 10 in a solution comprising the cationic resin, applying an anodic voltage to the fuel cell separator 10, and applying a cationic voltage to a counter electrode, the cationic resin is attracted to the fuel cell separator 10, and the cationic resin is deposited on the surface of the fuel cell separator 10. During this process, because the fuel cell separator 10 has been masked, the cationic resin is deposited on the areas not masked by the masking materials 56a and 56b, namely, substantially all of the peripheral area of the fuel cell separator 10. By performing this electrodeposition treatment, a uniform and dense film of the resin powder is coated onto the surface of the fuel cell separator 10 in the areas excluding the power generation area 12 and the short side portions 16 (see FIG. 1).

During electrodeposition of the resin, an anodic voltage is applied to the fuel cell separator 10 from the conductive portions (symbol 58 in FIG. 3) of the masking jig. As described above (see FIG. 3), the conductive portions make contact with the fuel cell separator 10 inside the power generation area that has been masked with the masking material 56a. In other words, the voltage for electrodepositing the resin is applied from the power generation area, which does not undergo resin electrodeposition.

If the voltage for electrodeposition of the resin is applied within the area in which the resin electrodeposition is being conducted, then current constriction or the like is more likely to occur within the area of voltage application, and uniform electrodeposition of the resin may not be possible. In contrast, in the present embodiment, because the voltage is applied from the power generation area, which does not undergo resin electrodeposition, current constriction or the like is unlikely to occur within the areas of resin electrodeposition, meaning a more uniform and dense resin film can be electrodeposited.

In the present embodiment, following the coating of the surface of the fuel cell separator 10 with the resin powder, the masking jig is removed from the fuel cell separator 10, and a baking treatment is performed to bake the resin powder onto the surface of the fuel cell separator 10. The uniformity and denseness of the resin coating are further improved by melting the resin powder adhered to the surface of the fuel cell separator 10, and the resin is subsequently cured, thereby forming a resin film 70 on the surface of the fuel cell separator 10.

Although a dense resin coating can be obtained by performing only the electrodeposition treatment, by melting the resin in a baking treatment, microscopic holes that exist between particles of the resin can be completely sealed, enabling the formation of an extremely dense and uniform resin film 70.

As illustrated in FIG. 4(C), because the resin film 70 is formed in this manner over substantially the entire peripheral area of the fuel cell separator 10, the openings (symbol 14 in FIG. 1) that function as the manifold are coated with the resin film 70.

Subsequently, as illustrated in FIG. 4(D), a plating film 80 is coated onto the surface of the fuel cell separator 10 having the resin film 70 formed thereon.

Electrodeposition coating is also used for the coating of the plating film 80, wherein an ionized metal (for example, a complex ion of gold) is electrodeposited on the surface of the fuel cell separator 10. During the electrodeposition treatment, by immersing the fuel cell separator 10 in a solution comprising metal complex ions, and causing a current to flow with the fuel cell separator 10 set as the cathode, the complex ions are attracted to the fuel cell separator 10, and the metal within these complex ions is deposited on the surface of the fuel cell separator 10. During this process, because the resin film 70 has been formed on the fuel cell separator 10, the resin film 70, which has insulating properties, functions as a mask. Accordingly, the metal within the complex ions is deposited within the area where the resin film 70 is not formed, namely, within the power generation area of the fuel cell separator 10, thereby forming the plating film 80.

During the electrodeposition of the metal complex ions, a cathodic current is applied to the fuel cell separator 10 from the short side portions 16. Because the short side portions 16 are masked by the masking material 56b during the resin electrodeposition, no resin is electrodeposited on these short side portions 16. Accordingly, the conductive material used for forming the fuel cell separator 10 (namely, the separator substrate) is exposed within the short side portions 16, and the current for electrodepositing the metal complex ions is applied from these exposed short side portions 16.

If the current is applied from the area in which the metal plating is being conducted, namely from the power generation area of the fuel cell separator 10, then current constriction or the like is more likely to occur, and uniform electrodeposition of the metal complex ions may not be possible. In contrast, in the present embodiment, because the current is applied from the short side portions 16 that are isolated from the power generation area, current constriction or the like is unlikely to occur within the power generation area, meaning a more uniform and dense film of the metal complex ions can be electrodeposited in the power generation area.

In this manner, as illustrated in FIG. 4(D), the resin film 70 is formed within the peripheral area of the fuel cell separator 10 (excluding the short side portions 16), while the plating film 80 is formed within the power generation area of the fuel cell separator 10.

In the present embodiment, the plating film 80 is formed following formation of the resin film 70 on the fuel cell separator 10, and no plating film 80 is disposed between the fuel cell separator 10 and the resin film 70. As a result, the durability of the adhesion between the fuel cell separator 10 and the resin film 70 is extremely high.

Furthermore, the plating film 80 is formed with the resin film 70 functioning as a mask, meaning the respective boundaries of the resin film 70 and the plating film 80 contact each other, forming a continuous coating. As a result, the boundary portion between the resin film 70 and the plating film 80 is very unlikely to act as a starting point for corrosion. Moreover, because the resin film 70 functions as a mask, a masking operation need not be conducted for the formation of the plating film 80.

The short side portions 16 where the fuel cell separator 10 (the separator substrate) is exposed also function as positioning portions which, when a plurality of unit cells each formed using a fuel cell separator 10 are laminated together to assemble a fuel cell, are used for positioning the plurality of unit cells relative to each other.

This positioning process performed during assembly of a fuel cell may employ the technique disclosed in JP 2005-243355 A. An outline of the positioning technique disclosed in this publication is described below. In the following description, the symbols within the parentheses represent the symbols used within the reference publication.

Exposed metal portions (symbols 46a, 46b and 46c) are provided on the outer periphery of a first metal separator (symbol 14), and exposed metal portions (symbols 56a, 56b and 56c) are provided on the outer periphery of a second metal separator (symbol 16). An electrolyte membrane-electrode assembly (symbol 12) is then sandwiched between the first metal separator and the second metal separator, thereby forming a fuel cell (symbol 10). An assembly apparatus (symbol 80) used for laminating a plurality of the fuel cells (symbol 10) and assembling a fuel cell stack (symbol 60) is provided with support rods (symbols 106a, 106b and 108). By bringing the exposed metal portion of each fuel cell (symbol 10) into contact with the support rods which extend across the stacking direction of the separators, the plurality of fuel cells (symbol 10) can be positioned accurately.

In the present embodiment, the short side portions 16 (positioning portions) where the fuel cell separator 10 is exposed perform the function of the exposed metal portions in the above publication. In other words, a MEA is sandwiched between two of the fuel cell separators 10 to form a unit cell, and during lamination of a plurality of these unit cells, the short side portions 16 (positioning portions) of the fuel cell separators 10 are used for positioning the unit cells relative to each other. For example, by using an assembly apparatus to laminate the plurality of unit cells, and supporting the short side portions 16 (positioning portions) with the assembly apparatus, the position of each unit cell is determined, meaning the plurality of unit cells can be positioned accurately relative to each other. The exposed metal portions are not only used during lamination of a plurality of cells, but may also be used for positioning separators when a single cell is formed by sandwiching a membrane electrode assembly between a pair of separators. In either case, because the exposed metal portions are positioned at the ends (the side surfaces) of the separator and have no resin adhered thereto, the positioning accuracy achievable using a positioning jig is very high.

A preferred embodiment of the present invention is described above, but in all respects, the above embodiment is merely exemplary, and in no way limits the scope of the present invention. For example, in the embodiment described above, an electrodeposition treatment is used during the resin coating, but instead of using this electrodeposition treatment, the resin coating may also be formed using injection molding or the like. Furthermore, in the case of the conductive coating, instead of using an electrodeposition treatment, another coating treatment such as painting, vacuum deposition, sputtering or ion plating may also be used. Moreover, instead of using gold (Au), the conductive coating may also be formed using copper, silver, platinum, palladium or carbon or the like.

Furthermore, in the present embodiment described above, as illustrated in FIG. 4, masking is conducted using the masking materials 56b, thereby exposing the short side portions 16, but the resin film 70 may also be formed without using the masking materials 56b, so that the resin film is also formed on the short side portions 16, and the resin film 70 on the short side portions 16 may then be partially removed, thereby exposing the short side portions 16. Furthermore, in the present embodiment, as illustrated in FIG. 1 and FIG. 4(D), the short side portions 16 of the fuel cell separator 10 are exposed, but at least a portion of the long side portions of the fuel cell separator 10 may be exposed instead. Moreover, in the present embodiment, as illustrated in FIG. 2, the clamping jigs 60 are fitted from the short sides of the fuel cell separator 10, but the clamping jigs 60 may also be fitted from the long sides of the fuel cell separator 10.

1. (canceled)

2. (canceled)

3. A method for manufacturing a fuel cell separator comprising a conductive coating and a resin coating formed on a plate-like separator substrate, the method comprising:
a first coating step of forming a resin coating within a peripheral area of the separator substrate that comprises an opening that functions as a manifold, so that the separator substrate is exposed within at least a portion of the peripheral area, and
a second coating step of forming a conductive coating within a power generation area of the separator substrate that faces a power generating layer, by causing electricity to flow through the separator substrate from the portion of the peripheral area where the separator substrate is exposed.

4. The method for manufacturing a fuel cell separator according to claim 3, wherein
the second coating step comprises coating the separator substrate, using a metal plating as the conductive coating, with the peripheral area that comprises an opening masked with the resin coating of the first coating step.

5. The method for manufacturing a fuel cell separator according to claim 3, wherein
when a plurality of unit cells are laminated together to assemble a fuel cell, the portion of the peripheral area where the separator substrate is exposed is used for positioning the plurality of unit cells relative to each other.
